(19) United States
(12) Patent Application Publication
(10) Pub. No.: US 2009/0238939 A1
(43) Pub. Date: Sep. 24, 2009

(54) DEFROSTING DEVICE

(76) Inventor: ITZEL MACHADO, Roselle Park, NJ (US)

Correspondence Address: James Ray & Associates, 2640 Pitcairn Road, Monroeville, PA, 15146, US

(21) Appl. No.: 12/406,230

(22) Filed: Mar. 18, 2009

Related U.S. Application Data
(60) Provisional application No. 61/037,349, filed on Mar. 18, 2008.

(51) Int. Cl. A23L 3/00; B65D 81/38; B65D 33/16; F24C 7/00

(52) U.S. Cl. 426/524; 383/110; 383/211; 219/386

(57) ABSTRACT

A defrosting device includes a substantially hollow liquid impervious housing having a predetermined size and a predetermined shape for receiving at least one of a predetermined frozen item, a predetermined amount of a predetermined liquid, and a combination thereof in an interior thereof. An access mechanism is disposed on such housing at a first predetermined location thereon for accessing such interior of such housing. A securing mechanism is operably disposed on such housing at a second predetermined location thereon closely adjacent such access mechanism for securing such access mechanism in a closed position.

### CROSS REFERENCE TO RELATED APPLICATION

This patent application is related to and claims priority from U.S. Provisional Patent Application Ser. No. 61/037,349 filed Mar. 18, 2008.

### FIELD OF THE INVENTION

The present invention relates, in general, to a defrosting device and, more particularly, this invention relates to a housing for receiving predetermined frozen items therein and within which such predetermined frozen items will be thawed.

### BACKGROUND OF THE INVENTION

Prior to the conception and development of the present invention, it is generally well known in the prior art to thaw items by microwaving, allowing such items to thaw in refrigerators and on countertops. However, microwaving may change the flavor and texture of food items and may partially cook such food items reducing the quality and appeal of such food items. Allowing items to thaw in a refrigerator or on a counter top can take extremely long periods of time. Furthermore, leaving food items on a counter top to thaw may result in bacterial growth which can cause consumers of such food items to become very ill.

Specifically of interest to the present invention are the following: Wojidkow, U.S. Pat. No. 1,045,101, discloses a plate for keeping hot food hot until eaten. Similarly, Wagner, U.S. Pat. No. 1,316,006, also discloses a plate for keeping hot food hot until eaten.

Takeda, U.S. Pat. No. 4,812,622, discloses a defrosting apparatus including a housing for accommodating articles to be defrosted, a heater for heating air within the housing, and an air circulation fan for circulating the heated air so that it flows through the space.

Mitsugu, U.S. Pat. No. 5,365,038, discloses a defroster having storage area for storing a heat releasing substance and a defrosting plate having a product supporting surface surrounded by an upstanding perimeter edge wall and arranged above the storage area. The storage area includes a hot water reservoir in a first embodiment and the storage area includes a mounting tray for holding a heating element in a second embodiment of the invention. The defroster also includes a cover which covers the product supporting surface.

Pearlman, U.S. Pat. No. 5,801,362, discloses an electrically heated convection oven with built-in rotisserie for rotisserie roasting, baking, broiling, defrosting, and dehydrating foodstuff which is characterized by the use of two motors. One for operating a fan which rotates within the heating chamber to create high velocity air flow throughout the heating chamber; the second one for rotating the rotisserie spit.

None of the above cited references provide the benefits attenuate with the present invention.

### SUMMARY OF THE INVENTION

The present invention provides a defrosting device which includes a substantially hollow liquid impervious housing having a predetermined size and a predetermined shape for receiving at least one of a predetermined frozen item, a predetermined amount of a predetermined liquid, and a combination thereof in an interior thereof. An access means is disposed on such housing at a first predetermined location thereon for accessing such interior of such housing. A securing means is operably disposed on such housing at a second predetermined location thereon closely adjacent such access means for securing such access means in a closed position.

A method of using a defrosting device includes the steps of providing a defrosting device including a substantially hollow liquid impervious housing having a predetermined size and a predetermined shape and including an access means disposed on said housing at a first predetermined location for accessing said interior of said housing and a securing means operably disposed on said housing at a second predetermined location thereon closely adjacent said access means for securing said access means in a closed position; placing a predetermined item in such interior portion of such housing; placing a predetermined amount of a predetermined liquid having a predetermined temperature in such interior portion of such housing; securing such access means in a closed position; waiting a predetermined amount of time for such predetermined item to thaw; and removing such predetermined item from such housing once such predetermined item is thawed.

### OBJECTS OF THE INVENTION

It is, therefore, one of the primary objects of the present invention to provide a disposable defrosting device for quickly and easily defrosting predetermined consumable items such as meats, fish, and the like.

Another object of the present invention is to provide a defrosting bag which is easy to use and which greatly decreases the amount of time necessary to thaw predetermined consumable items.

Still another object of the present invention is to provide an insulated bag which can be filled with heated water of a predetermined temperature, such bag retaining the heat of such water such that such heat is applied to a predetermined frozen or partially frozen item within such bag such that such predetermined item is thawed from being in proximity to such heat.

Yet another object of the present invention is to provide a simple economical device for thawing frozen beef, fish, poultry, lamb, and other meats and foodstuffs and which is inexpensive and easy to use.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention; a frozen steak is depicted beside the invention.

FIG. 2 is a partial perspective view of the invention according to one embodiment of the invention; a user of the device is illustrated placing the frozen steak of FIG. 1 within the housing.

FIG. 3 is a partial perspective view of the invention according to one embodiment of the invention; the user of FIG. 2 is illustrated pouring a predetermined amount of a predetermined liquid into the housing over the frozen steak of FIG. 1 and 2.

FIG. 4 is a partial perspective view of the invention according to one embodiment of the invention; the user of FIG. 2 and 3 is illustrated securing the access opening of the housing of FIGS. 1, 2, and 3 in a closed position.

FIG. 5 is a partial perspective view of the invention according to one embodiment of the invention in which such housing is a bag having four side walls.

FIG. 6 is a partial perspective view of the invention according to one embodiment of the invention in which such housing is such bag as shown in FIG. 5 and such bag is shown in a closed position with a clip type securing means retaining such bag in such closed position.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

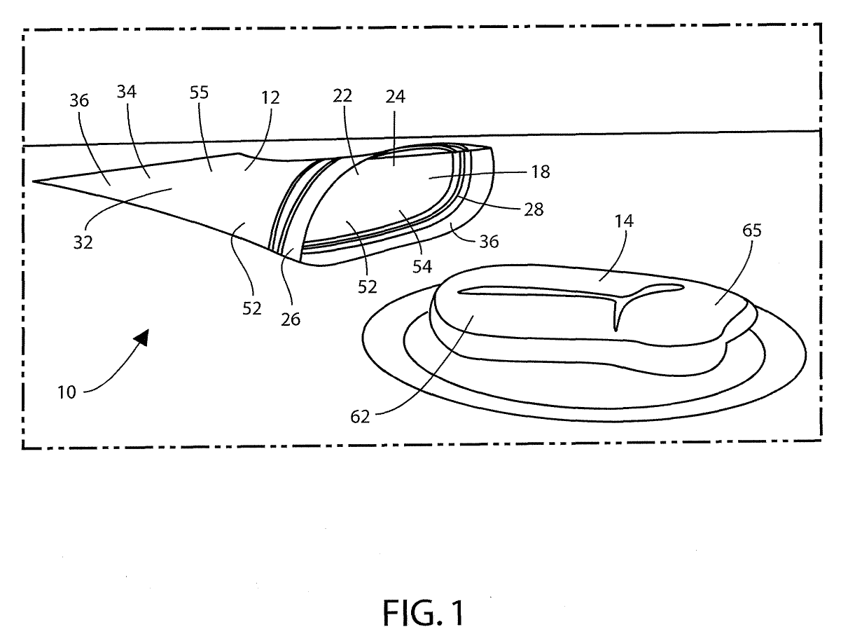

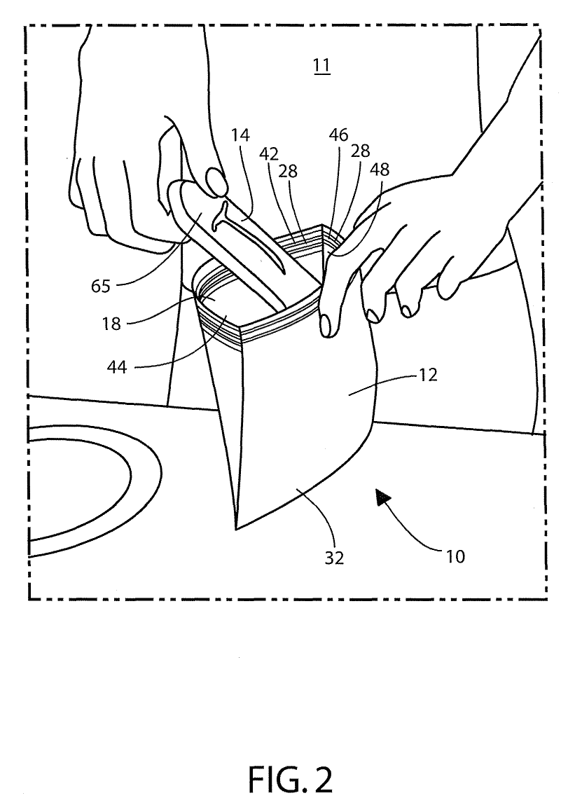

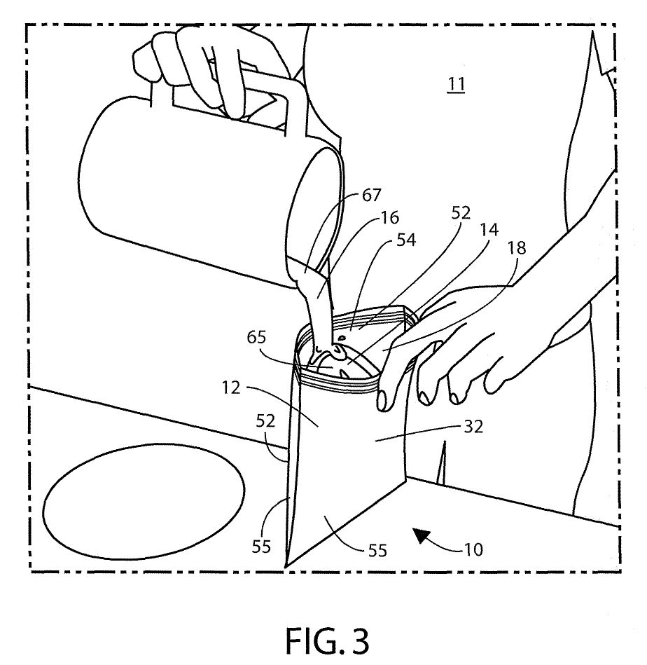

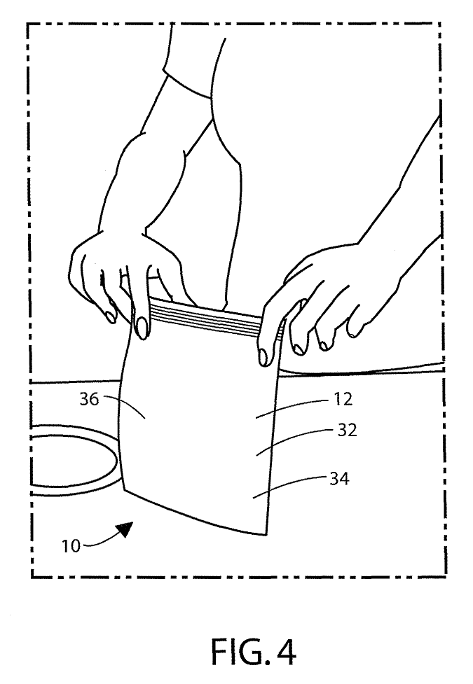

Reference is now made, more particularly, to FIGS. 1-6.

The present invention provides a defrosting device, generally designated 10, which includes a substantially hollow liquid impervious housing 12 having a predetermined size and a predetermined shape for receiving at least one of a predetermined frozen item 14, a predetermined amount of a predetermined liquid 16, and a combination thereof in an interior 18 thereof. It is presently preferred that such housing 12 is insulated.

An access means 22 is disposed on such housing 12 at a first predetermined location thereon for accessing such interior 18 of such housing 12. It is presently preferred that such access means 22 is an opening 24 disposed at a top end 26 of such housing 12.

A securing means 28 is operably disposed on such housing 12 at a second predetermined location thereon closely adjacent such access means 22 for securing such access means 22 in a closed position.

It is presently preferred that such housing 12 is manufactured from at least one of plastic, metal, fabric, and a combination thereof. Such metal is preferably aluminum. Such plastic is preferably polyethylene. It is further presently preferred that such housing 12 is formed as a bag 32.

According to a preferred embodiment, as illustrated in FIGS. 1-4, such bag 32 includes at least one elongated panel 34 folded in half to form side walls 36 of such bag 32, such side walls 36 being connected to each other at side edges thereof.

It is further presently preferred that such securing means 28 includes a male portion 42 disposed on a first interior side wall 44 of such bag 32 and a female portion 46 disposed on a second interior side wall 48 of such bag 32, such male portion 42 and female portion 46 being engageable with each other and each extending to right and left ends of such bag 32.

It is presently preferred that such bag 32 is formed from a plurality of layers 52 manufactured from a plurality of predetermined materials. It is further presently preferred that such bag 32 includes at least a first water impervious inner layer 54 manufactured from a first predetermined material and a second insulating outer layer 55 manufactured from a second predetermined material.

It is presently preferred that such predetermined liquid has a predetermined temperature. Furthermore, it is presently preferred that such predetermined liquid 16 is water 67. It is presently preferred that such predetermined frozen item 14 is a predetermined food item 62. It is further presently preferred that such predetermined food item 62 is at least one of beef, poultry, pork, fish, lamb, and a combination thereof.

It is meant that a user 11 place such predetermined frozen item 14 in such housing 12 along with such predetermined liquid 16, for example, water which has been heated to a predetermined temperature may serve as such predetermined liquid and such predetermined frozen item may be meat, such as a steak 65, as illustrated in FIGS. 1, 2, and 3. The insulated housing 12 will retain the heat from the heated predetermined liquid 16 such that the heat is applied to the predetermined frozen item 14 and such predetermined frozen item will thaw.

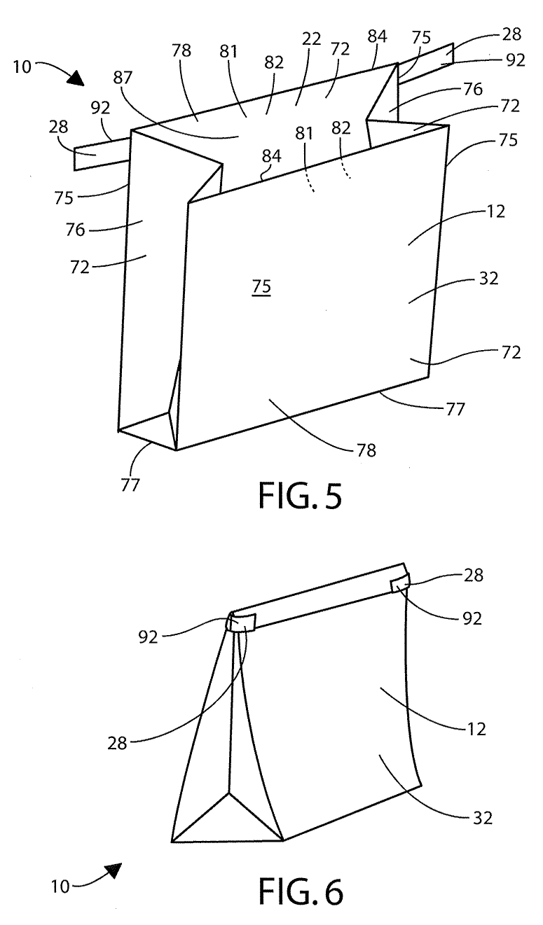

According to another embodiment, as illustrated in FIG. 5 and FIG. 6, such housing is such bag 32 and such bag 32 includes four side walls 72 connected to each other at side edges 75 thereof and includes a bottom wall (not shown) connected to each of such side walls 72 at bottom edges 77 thereof, such side walls 72 of such bag 12 being flexible such that predetermined portions of two predetermined opposite side walls 76 may be forced inward at predetermined locations such that inner portions 81 of a remaining two opposite side walls 78 may be brought together at top ends 82 thereof for closing an opening 87 closely adjacent top edges 84 of such bag 32. Various types of securing means may be implemented to close such bag. For example, such securing means may be at least one of adhesive, at least one clamp, at least one clip, a hook and loop type securing means, and a combination thereof. As shown in FIGS. 5-6 such securing means 28 includes a pair of clips disposed on such bag, such clips may be bendable wire clips. The top of the bag is closed via forcing portions of side walls 76 inwards and bringing side walls 78 together at top ends 82 thereof then the top of such bag can be folded or rolled downward and sides joined by such clips to secure such opening in such closed position.

According to the preferred embodiment such defrosting device 10 is disposable.

According to a another embodiment such defrosting device is at least one of washable, reusable, and a combination thereof.

According to yet another embodiment, a method of using a defrosting device includes the steps of providing a defrosting device including a substantially hollow liquid impervious housing having a predetermined size and a predetermined shape and including an access means disposed on such housing at a first predetermined location for accessing such interior of such housing and a securing means operably disposed on such housing at a second predetermined location thereon closely adjacent such access means for securing such access means in a closed position; placing a predetermined item in such interior portion of such housing; placing a predetermined amount of a predetermined liquid having a predetermined temperature in such interior portion of such housing; securing such access means in a closed position; waiting a predetermined amount of time for such predetermined item to thaw; and removing such predetermined item from such housing once such predetermined item is thawed.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A defrosting device comprising:
a. a substantially hollow liquid impervious housing having a predetermined size and a predetermined shape for receiving at least one of a predetermined frozen item, a predetermined amount of a predetermined liquid, and a combination thereof in an interior thereof;
b. an access means disposed on said housing at a first predetermined location thereon for accessing said interior of said housing; and
c. a securing means operably disposed on said housing at a second predetermined location thereon closely adjacent said access means for securing said access means in a closed position.

2. A defrosting device according to claim 1 wherein said housing is manufactured from at least one of plastic, metal, fabric, and a combination thereof.

3. A defrosting device according to claim 2 wherein said metal is aluminum.

4. A defrosting device according to claim 2 wherein said plastic is polyethylene.

5. A defrosting device according to claim 1 wherein said housing is formed as a bag.

6. A defrosting device according to claim 5 wherein said bag includes at least one elongated panel folded in half to form side walls of said bag, each of said side walls being connected to each other at side edges thereof.

7. A defrosting device according to claim 6 wherein said securing means includes a male portion disposed on a first interior side wall of said bag and a female portion disposed on a second interior side wall of said bag, said male and female portions being engageable with each other and each extending to right and left ends of said bag.

8. A defrosting device according to claim 1 wherein said predetermined liquid is water.

9. A defrosting device according to claim 5 wherein said bag includes four side walls connected to each other at side edges thereof and a bottom wall connected to each of said side walls at bottom edges thereof, said side walls of said bag being flexible such that predetermined portions of two predetermined opposite side walls may be forced inward at a predetermined location in a predetermined manner such that inner portions of a remaining two opposite side walls may be brought together at top ends thereof for closing an opening adjacent top edges of said bag.

10. A defrosting device according to claim 9 wherein said securing means is at least one of adhesive, at least one clamp, at least one clip, a hook and loop type securing means, and a combination thereof.

11. A defrosting device according to claim 1 wherein said predetermined liquid is a predetermined temperature.

12. A defrosting device according to claim 1 wherein said predetermined frozen item has a predetermined food item.

13. A defrosting device according to claim 9 wherein said predetermined food item is at least one of beef, poultry, pork, fish, lamb, and a combination thereof.

14. A defrosting device according to claim 1 wherein said housing member is insulated.

15. A defrosting device according to claim 1 wherein said access means is an opening disposed at a top end of said housing.

16. A defrosting device according to claim 1 wherein said device is disposable.

17. A defrosting device according to claim 1 wherein said device is at least one of washable, reusable, and a combination thereof.

18. A defrosting device according to claim 4 wherein said bag is formed from a plurality of layers manufactured from a plurality of predetermined materials.

19. A defrosting device according to claim 18 wherein said bag includes at least a first water impervious inner layer manufactured from a first predetermined material and a second insulating layer manufactured from a second predetermined material.

20. A method of using a defrosting device comprising the steps of:
a. providing a defrosting device including a substantially hollow liquid impervious housing having a predetermined size and a predetermined shape including an access means disposed on said housing at a first predetermined location for accessing said interior of said housing and a securing means operably disposed on said housing at a second predetermined location thereon closely adjacent said access means for securing said access means in a closed position;
b. placing a predetermined item in said interior portion of said housing;
c. placing a predetermined amount of a predetermined liquid having a predetermined temperature in said interior portion of said housing;
d. securing said access means in a closed position;
e. waiting a predetermined amount of time for such predetermined item to thaw; and
f. removing such predetermined item from said housing once said predetermined item is thawed.
